(19) United States
(12) Patent Application Publication
(10) Pub. No.: US 2011/0314129 A1
(43) Pub. Date: Dec. 22, 2011

(54) BINDING/AGGREGATING MULTIPLE INTERFACES AT APPLICATION LAYER

(76) Inventors: Ramin Rezaiifar, San Diego, CA (US); Robert H. Kimball, Encinitas, CA (US)

(21) Appl. No.: 12/965,700

(22) Filed: Dec. 10, 2010

Related U.S. Application Data
(60) Provisional application No. 61/288,119, filed on Dec. 18, 2009.

(51) Int. Cl. G06F 15/16

(52) U.S. Cl. 709/218

(57) ABSTRACT

A bundler utility of a client accomplishes an objective of binding/aggregating two or more network interfaces at an application layer to increase bandwidth that the application layer can use. This interface is determined by the longest prefix match in the routing table of the device. Rather than imposing a change to the IP stack, the bundler utility presents a solution to the link aggregation problem that can be deployed without requiring any change to the client software (e.g., no browser change) and without requiring changes on the web servers.

### CLAIM OF PRIORITY UNDER 35 U.S.C. §119

The present application for patent claims priority to Provisional Application No. 61/288,119 entitled “HTTP Optimization, Multi-Homing, Mobility and Priority” filed Dec. 18, 2009, and assigned to the assignee hereof and hereby expressly incorporated by reference herein.

### REFERENCE TO CO-PENDING APPLICATIONS FOR PATENT

The present application for patent is related to the following co-pending U.S. patent application “HTTP OPTIMIZATION, MULTI-HOMING, MOBILITY AND PRIORITY” by Mark Watson, et al., having Attorney Docket No. 100528U1, filed concurrently herewith, assigned to the assignee hereof, and expressly incorporated by reference herein

### BACKGROUND

1. Field

The present disclosure relates generally to communication, and more specifically to techniques for retrieving hypertext packet data content in a wireless communication network.

2. Background

Hypertext Transfer Protocol (HTTP) is the primary communication protocol used by web browsers and web applications. A large infrastructure has grown up within the Internet to support efficient operation of the HTTP protocol in the form of Content Delivery Networks. As a result an increasing number of applications are migrating to the HTTP protocol. While there are other reasons for this migration (e.g., Network Address Translation (NAT) and firewall traversal), it is the ability to leverage the massive scalability of the web infrastructure that is the main driver.

Web sites today are often extremely complex, comprising tens or hundreds of objects that must each be separately requested using HTTP. Various optimizations have been defined within HTTP to improve the speed with which the objects can be transported from server to client. A considerable amount of work has been done on application of these optimizations within wired networks; however it remains an unsolved problem to understand how these features behave and combine in the more challenging mobile environments with high Round Trip Time (RTT) and highly variable bandwidth. In particular it should be noted that much HTTP work was carried out some years ago at which time the characteristics of mobile networks differed considerably from today.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In one aspect, a method is provided for packet data communications by bundling a plurality of network interfaces, establishing a number of parallel connections for packet data communication via the bundled plurality of network interfaces, and transmitting a plurality of requests via the number of parallel connections for retrieving Hypertext Transfer Protocol (http) objects comprised of packet data portions respectively stored on web servers.

In another aspect, at least one processor is provided for packet data communications. A first module bundles a plurality of network interfaces. A second module establishes a number of parallel connections for packet data communication via the bundled plurality of network interfaces. A third module transmits a plurality of requests via the number of parallel connections for retrieving a http object comprised of packet data portions respectively stored on web servers.

In an additional aspect, a computer program product is provided for packet data communications comprises a non-transitory computer-readable storage medium that stores sets of code. A first set of code causes a computer to bundle a plurality of network interfaces. A second set of code causes the computer to establish a number of parallel connections for packet data communication via the bundled plurality of network interfaces. A third set of code causes the computer to transmit a plurality of requests via the number of parallel connections for retrieving a http object comprised of packet data portions respectively stored on web servers.

In a further aspect, an apparatus is provided for packet data communications. The apparatus comprises means for bundling a plurality of network interfaces. The apparatus comprises means for establishing a number of parallel connections for packet data communication via the bundled plurality of network interfaces. The apparatus comprises means for transmitting a plurality of requests via the number of parallel connections for retrieving http objects comprised of packet data portions respectively stored on web servers.

In yet another aspect, an apparatus is provided for packet data communications using a plurality of network interfaces. A bundler utility bundles the plurality of network interfaces. The bundler utility establishes a number of parallel connections for packet data communication via the bundled plurality of network interfaces. The plurality of network interfaces transmits a plurality of requests via the number of parallel connections for retrieving a http object comprised of packet data portions respectively stored on web servers.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a schematic diagram of a communication system using bundling of network interfaces and proxy server for Hypertext Transfer Protocol (HTTP) optimization.

FIG. 2 illustrates a schematic diagram of a communication system for an exemplary radio access technologies for HTTP optimization.

FIG. 3 illustrates a flow diagram for a methodology for bundling of network interfaces.

FIG. 4 illustrates a system of logical grouping of electrical components for bundling of network interfaces.

FIG. 5 illustrates a schematic diagram of a communication system for HTTP optimization.

FIG. 6 illustrates a block diagram for a mobile terminal that performs HTTP optimization.

### DETAILED DESCRIPTION

Benefits exist in combining parallel HTTP connections and pipelining to overcome an impact of increasing Round Trip Time (RTT). Generally known browsers employ a fixed number of parallel connections and a fixed number of outstanding requests, albeit the number of parallel connections is influenced by the set of distinct servers that must be contacted.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

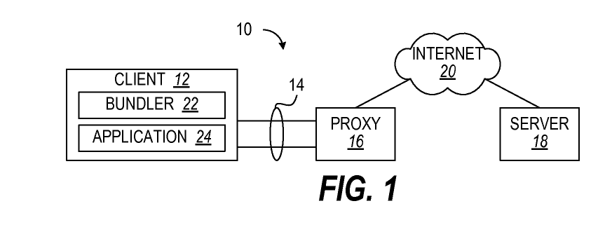

In FIG. 1, a communication system 10 is depicted of a client 12 having multiple interfaces 14 to a proxy 16 for packet data communication to a server 18 via a packet data network, depicted as Internet 20. A bundler utility 22 of the client 12 via the proxy 16 accomplishes an objective of binding/aggregating two or more interfaces 14 at an application layer 24 together for the purpose of increasing the bandwidth that the application layer 24 can use.

Thus, the client 12 can overcome a challenge in that many communication devices (e.g., laptops and handheld devices) are equipped with more than one interface (e.g., WIFI, 3G, wire-line Ethernet, etc.). When an application on the client sends a packet to a destination IP address, the packet is bound to go on a single interface. This interface is determined by the longest prefix match in the routing table of the device. Rather than imposing a change to the IP stack, the present innovation presents a solution to the link aggregation problem that can be deployed without requiring any change to the client software (i.e., no browser change) and without requiring changes on the web servers.

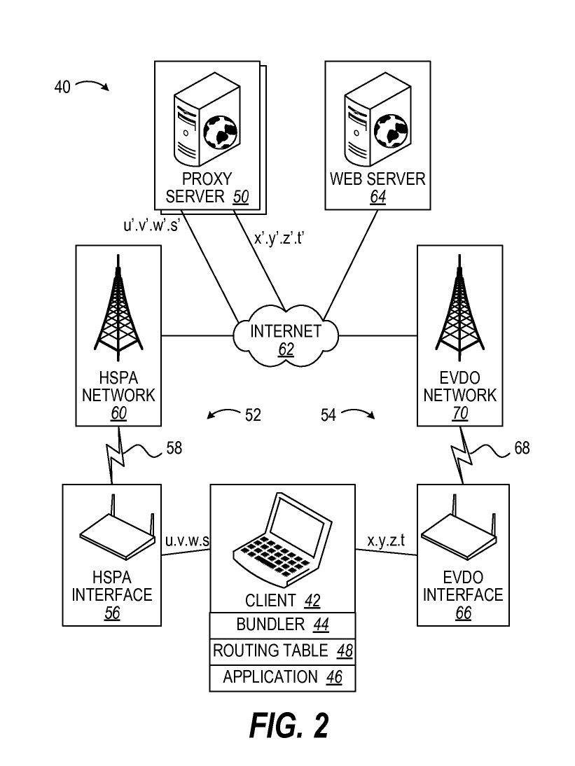

In FIG. 2, an exemplary aspect depicts a communication system 40 wherein a client 42 incorporates a bundler utility 44 that optimizes operation of an application 46 by avoiding a routing table 48 dictating a single interface by using a proxy (server) 50 with two or more NIC (Network Interface Controller) cards.

The routing table 48 in the client 42 is configured to have distinct routes 52, 54 to each of the proxy IP addresses and each of these distinct routing table entries are bound to a different interface on the client. For example, packets destined to IP address IP_{—}1 of the proxy are sent on the client's WIFI interface and packets destined to IP address IP_{—}2 of the proxy are sent on the clients 3G interface. In an illustrative depiction, the first route comprises a High-Speed Packet Access (HSPA) interface 56, an air interface 58 to HSPA network 60 to the proxy server 50 via Internet 62, which in turn can access a destination web server 64. The second route comprises an Evolution Data Optimized, also known as Evolution Data Only, (EVDO) interface 66, an air interface 68, EVDO network 70 to the proxy server 50 via Internet 62, which in turn can access the destination web server 64.

Alternatively or in addition to a single proxy server 50, a plurality of proxy servers 50 can be employed, either using the same network interface, different network interfaces, or a combination thereof. Using separate servers may have the advantage that each proxy server for each of the client's network interfaces may reside in a place that is closer to the gateway for that interface. For example, the proxy for HSPA interface may reside close to the HSPA network gateway and the same for the EVDO proxy.

Now, the application 46 such as a browser needs to distribute HTTP GET commands across the multiple proxy IP addresses. This can be done using a PAC script (Proxy auto-configuration script). A PAC script maps a URL to a proxy address. Almost all browsers/OSs support PAC scripts. The following is an example PAC script for bundling two client interfaces. In this script, proxy_a and proxy_b are two IP addresses associated with the proxy (or proxies).

var N = 2;
function FindProxyForURL(url, host)
{

var i = url.length % N;
if(i == 0)

return “PROXY proxy_a:8080; ”

else if(i == 1)

return “PROXY proxy_b:8080; ”

}

In TABLE A, active routes can include the two proxy addresses that include respectively modem addresses (“interface”) for EVDO and HSPA:

TABLE A

| Routing | Network | | | | |
|---|---|---|---|---|---|
| Table | Destination | Netmask | Gateway | Interface | Metric |
| | . . . | | | | |
| HSPA | 199.106.114.135 | 255.255.255.255 | On-link | 75.213.222.248 | 51 |
| | | | | (proxy_a IP address) | |
| EVDO | 199.106.114.169 | 255.255.255.255 | 10.72.64.1 | 10.72.74.177 | 4251 |
| | | | | (proxy_b IP address) | |
| | . . . | | | | |

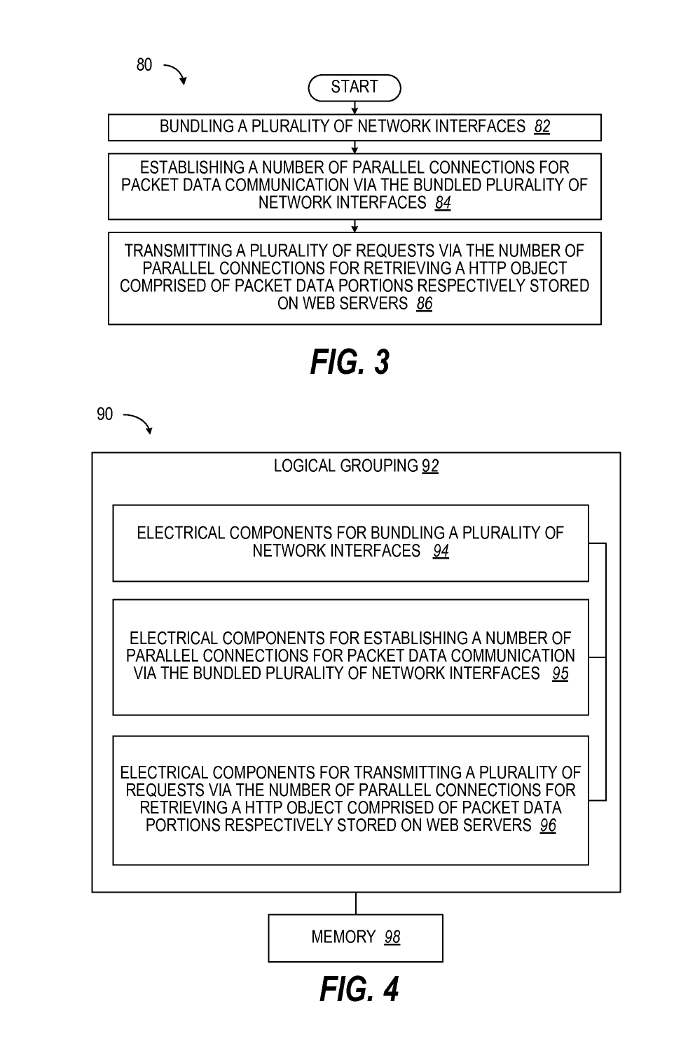

In FIG. 3, a methodology 80 is depicted for data communication. In block 82, a client bundles a plurality of network interfaces. In block 84, the client establishes a number of parallel connections for packet data communication via the bundled plurality of network interfaces. In block 86, the client transmits a plurality of requests via the number of parallel connections for retrieving Hypertext Transfer Protocol (http) objects comprised of packet data portions respectively stored on web servers.

For example, a bundler utility or method can be used to download multiple objects in parallel or to download portions of a large object in parallel, such as to download a large audiovisual file (e.g., movie). To that end, the client can submit requests for different segments of the movie on different interfaces in parallel. Thus, different segments of an HTTP object can be received in parallel over multiple network interfaces.

In another aspect, bundling the plurality of network interfaces can be by Ethernet, Wireless Wide Area Network (WWAN) of a first Radio Access Technology (RAT), a WWAN of a second RAT, a wired network interface, a wired Local Access Network (LAN) Local Access Network (WLAN), and a wired LAN. The selected two can be the same type of network interface.

In one aspect, establishing the number of parallel connections can be in response to determining that bandwidth of available interfaces are of a same order of magnitude.

In an additional aspect, transmitting the plurality of requests can be done to maintain full link utilization by aggregating links for multi-homed hosts with connection round robin.

In addition, transmitting the plurality of requests can be by installing static routing table entries that bind an IP address of each of the proxy servers as the destination address in the routing table to one of the network interfaces of a client.

In a further aspect, Proxy Auto Configuration (PAC) can be used to distribute HTTP requests across multiple proxy servers, either by a deterministic process or a random process.

In one aspect, bundling a plurality of network interfaces can be by defining a plurality of distinct routing table entries each bound to a respective interface on a client, such as by linking to respective and corresponding network interfaces on a proxy server.

With reference to FIG. 4, illustrated is a system 90 for packet data communications. For example, system 90 can reside at least partially within user equipment (UE). It is to be appreciated that system 90 is represented as including functional blocks, which can be functional blocks that represent functions implemented by a computing platform, processor, software, or combination thereof (e.g., firmware). System 90 includes a logical grouping 92 of electrical components that can act in conjunction. For instance, logical grouping 92 can include an electrical component 94 for bundling a plurality of network interfaces. Moreover, logical grouping 92 can include an electrical component 95 for establishing a number of parallel connections for packet data communication via the bundled plurality of network interfaces. In addition, logical grouping 92 can include an electrical component 96 for transmitting a plurality of requests via the number of parallel connections for retrieving HTTP objects comprised of packet data portions respectively stored on web servers. Additionally, system 90 can include a memory 98 that retains instructions for executing functions associated with electrical components 94-98. While shown as being external to memory 98, it is to be understood that one or more of electrical components 94-96 can exist within memory 98.

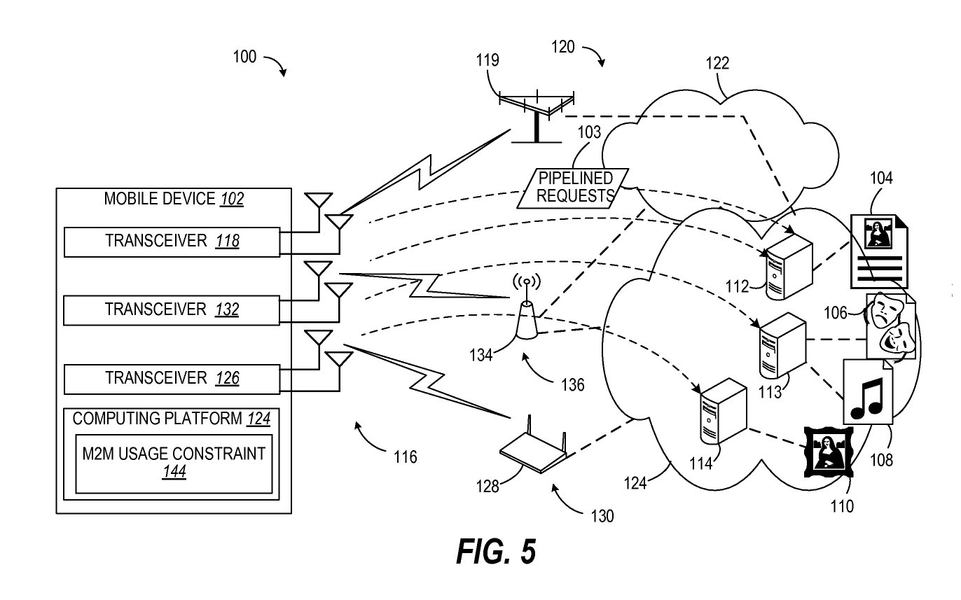

In FIG. 5, in a communication system 100, a mobile device, access terminal, or User Equipment (UE) 102 makes pipelined requests 103 for hypertext content 104 containing objects 106, 108, 110 stored on web servers 112-114. In an exemplary aspect, mobile device 102 gains access via an airlink 116 that aggravates a Round Trip Time (RTT) required to receive the objects 106-110 and thus to render the hypertext content 104. In one aspect, the mobile device 102 has a radio transceiver 118 for communicating with a node (e.g., macrocell, femtocell, relay) 119 that serves as part of a Wireless Wide Area Network (WWAN) 120 to an Internet Protocol Multimedia Subsystem (IMS) 122 to the servers 112-114 hosted in a Core Network (CN) (e.g., Internet) 124.

Alternatively or in addition, the mobile device 102 has a transceiver 126 for communicating with a node 128 that serves a Wireless Local Access Network (WLAN) 130 for accessing the servers 112-114 via CN 124.

Alternatively or in addition, the mobile device 102 has a transceiver 132 for communicating with a node 134 that serves a Personal Access Network (PAN) 136 and is coupled to either the WWAN 120 or the WLAN 130 for reaching the servers 112-114 via CN 124.

In one aspect, the transceiver(s) 118, 126, 132 establish a number of parallel connections for packet data communication. The transceiver(s) 118, 126, 132 further transmit a plurality of pipelined requests via the number of parallel connections for retrieving a hypertext object comprised of packet data portions respectively stored on web servers.

A computing system 124 of the mobile device 102 has an HTTP optimization component 144 dynamically varies the number of parallel connections and pipelined requests via the parallel connections to reduce outstanding requests while maintaining full link utilization.

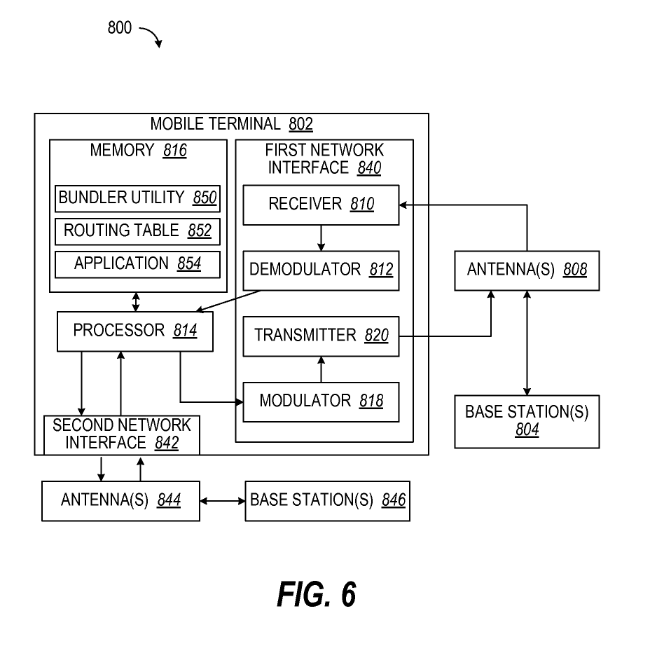

FIG. 6 is a block diagram of another system 800 that can be utilized to implement various aspects of the functionality described herein. In one example, system 800 includes a mobile terminal 802. As illustrated, mobile terminal 802 can receive signal(s) from one or more base stations 804 and transmit to the one or more base stations 804 via one or more antennas 808. Additionally, mobile terminal 802 can comprise a receiver 810 that receives information from antenna(s) 808. In one example, receiver 810 can be operatively associated with a demodulator 812 that demodulates received information. Demodulated symbols can then be analyzed by a processor 814. Processor 814 can be coupled to memory 816, which can store data and/or program codes related to mobile terminal 802. Additionally, mobile terminal 802 can employ processor 814 to perform methodologies described herein. Mobile terminal 802 can also include a modulator 818 that can multiplex a signal for transmission by a transmitter 820 through antenna(s) 808.

The mobile terminal 802 can have a plurality of network interfaces 840, 842, the latter depicted as utilizing antenna(s) 844 to reach base stations 846. For example, a base station 804, 846 can support one or more of Ethernet, Wireless Wide Area Network (WWAN) of a first Radio Access Technology (RAT), a WWAN of a second RAT, a wired Local Access Network (LAN) and Wireless Local Access Network (WLAN). A bundler utility 850 can optimize a routing table 852 such that an application 854 uses the plurality of network interfaces 840, 842 according to aspects disclosed herein.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for packet data communications, the method comprising:
bundling a plurality of network interfaces;
establishing a number of parallel connections for packet data communication via the bundled plurality of network interfaces; and
transmitting a plurality of requests via the number of parallel connections for retrieving Hypertext Transfer Protocol (http) objects comprised of packet data portions respectively stored on web servers.

2. The method of claim 1, wherein retrieving HTTP objects further comprises retrieving different segments of an HTTP object.

3. The method of claim 1, wherein bundling the plurality of network interfaces further comprising selecting at least two from a group consisting of Ethernet, Wireless Wide Area Network (WWAN) of a first Radio Access Technology (RAT), a WWAN of a second RAT, a wired network interface, a wired Local Access Network (LAN) Local Access Network (WLAN), wherein the selected two can be the same type of network interface.

4. The method of claim 1, wherein establishing the number of parallel connections further comprises determining that bandwidth of available interfaces are of a same order of magnitude.

5. The method of claim 1, wherein transmitting the plurality of requests further comprises maintaining full link utilization by aggregating links for multi-homed hosts with connection round robin.

6. The method of claim 5, wherein transmitting the plurality of requests further comprises installing static routing table entries that bind an IP address of each of the proxy servers as the destination address in the routing table to one of the network interfaces of a client.

7. The method of claim 6, further comprising using Proxy Auto Configuration (PAC) in order to distribute HTTP requests across multiple proxy servers.

8. The method of claim 7, wherein using PAC further comprises distributing according to a selected one of a deterministic process and a random process.

9. The method of claim 1, wherein bundling a plurality of network interfaces further comprises defining a plurality of distinct routing table entries each bound to a respective interface on a client.

10. The method of claim 9, wherein defining the plurality of distinct routing table entries further comprises linking to respective and corresponding network interfaces on a proxy server.

11. At least one processor for packet data communications, the at least one processor comprising:
a first module for bundling a plurality of network interfaces;
a second module for establishing a number of parallel connections for packet data communication via the bundled plurality of network interfaces; and
a third module for transmitting a plurality of requests via the number of parallel connections for retrieving Hypertext Transfer Protocol (http) objects comprised of packet data portions respectively stored on web servers.

12. A computer program product for packet data communications, the computer program product comprising:
a non-transitory computer-readable storage medium comprising:
a first set of code for causing a computer to bundle a plurality of network interfaces;
a second set of code for causing the computer to establish a number of parallel connections for packet data communication via the bundled plurality of network interfaces; and
a third set of code for causing the computer to transmit a plurality of requests via the number of parallel connections for retrieving Hypertext Transfer Protocol (http) objects comprised of packet data portions respectively stored on web servers.

13. An apparatus for packet data communications, the apparatus comprising:
means for bundling a plurality of network interfaces;
means for establishing a number of parallel connections for packet data communication via the bundled plurality of network interfaces; and
means for transmitting a plurality of requests via the number of parallel connections for retrieving Hypertext Transfer Protocol (http) objects comprised of packet data portions respectively stored on web servers.

14. An apparatus for packet data communications, the apparatus comprising:
a plurality of network interfaces;
a bundler utility for bundling the plurality of network interfaces;
the bundler utility for establishing a number of parallel connections for packet data communication via the bundled plurality of network interfaces; and
the plurality of network interfaces for transmitting a plurality of requests via the number of parallel connections for retrieving Hypertext Transfer Protocol (http) objects comprised of packet data portions respectively stored on web servers.

15. The apparatus of claim 14, wherein the bundler is further for retrieving HTTP objects by retrieving different segments of an HTTP object.

16. The apparatus of claim 14, wherein the bundler is further for bundling the plurality of network interfaces by selecting at least two from a group consisting of Ethernet, Wireless Wide Area Network (WWAN) of a first Radio Access Technology (RAT), a WWAN of a second RAT, a wired network interface, a wired Local Access Network (LAN) Local Access Network (WLAN), wherein the selected two can be the same type of network interface.

17. The apparatus of claim 14, wherein the bundler is further for establishing the number of parallel connections by determining that bandwidth of available interfaces are of a same order of magnitude.

18. The apparatus of claim 14, wherein the bundler is further for maintaining full link utilization by aggregating links for multi-homed hosts with connection round robin.

19. The apparatus of claim 18, wherein the bundler is further for installing static routing table entries that bind an IP address of each of the proxy servers as the destination address in the routing table to one of the network interfaces of a client.

20. The apparatus of claim 19, the bundler is further for using Proxy Auto Configuration (PAC) in order to distribute HTTP requests across multiple proxy servers.

21. The apparatus of claim 20, wherein the bundler is further for using PAC by distributing according to a selected one of a deterministic process and a random process.

22. The apparatus of claim 14, wherein the bundler is further for bundling a plurality of network interfaces by defining a plurality of distinct routing table entries each bound to a respective interface on a client.

23. The apparatus of claim 22, wherein the bundler is further for defining the plurality of distinct routing table entries by linking to respective and corresponding network interfaces on a proxy server.
